(19) United States
(12) Patent Application Publication
(10) Pub. No.: US 2009/0193459 A1
(43) Pub. Date: Jul. 30, 2009

(54) CHANNEL SELECTION BY NAME

(75) Inventor: Eric Hsiao, San Diego, CA (US)

Correspondence Address: ROGITZ & ASSOCIATES, 750 B STREET, SUITE 3120, SAN DIEGO, CA, 92101, US

(73) Assignee: Sony Corporation and Sony Electronics Inc.

(21) Appl. No.: 12/021,655

(22) Filed: Jan. 29, 2008

(51) Int. Cl. G06F 3/00

(52) U.S. Cl. 725/38

(57) ABSTRACT

A method to directly tune to a specific station. Each number of a TV remote control keypad represents certain letters. A viewer enters the number that corresponds to each letter of the call letters of a desired TV station, and the TV uses metadata such as program and system information protocol (PSIP) information in received programming streams to dynamically correlate the station name to a channel number and tune to the channel number.

### I. FIELD OF THE INVENTION

The present invention relates generally to selecting a TV channel by inputting a name or call sign of the channel instead of its channel number.

### II. BACKGROUND OF THE INVENTION

The present invention critically recognizes that it is easier for humans to remember the name of something instead of a number. For example, it is easy to remember the call letters “ABC” as a TV station name but not always what channel number it is associated with in the local channel lineup. This is especially true when visiting someone who lives in an area with a different channel lineup from one's own.

As understood herein, a TV or set-top box can provide an on-screen guide which the user can access to search for a particular channel. However, this is slower than being able to key in the call letters directly and tune right away.

### SUMMARY OF THE INVENTION

A method includes receiving, at a TV, a signal from a wireless commander, and determining an alphabetic station identification from the signal. Metadata in incoming TV signals is accessed to determine a channel number associated with the station identification. Then, the TV is tuned to the channel number.

In some embodiments the metadata is accessed dynamically after receipt of the signal from the wireless commander. The wireless commander can be, e.g., a wireless telephone or a TV remote control. The station identification typically is alphanumeric in that it includes at least one letter, and the metadata that is accessed to correlate the station identification to a channel number can be program and system information protocol (PSIP) data.

In another aspect, a system includes a TV display and a processor associated with the TV display. A tuner is controllable by the processor to cause programming from a tuned-to channel number to be presented on the display. The processor receives user-generated signals and correlates the signals to a station call sign. The processor then correlates the call sign to a channel number using information received in TV programming.

In still another aspect, an apparatus for obviating the need for a viewer to remember a channel number of a desired station having an alphabetic identification includes a TV receiving a signal from a viewer-operated input device. The signal is input by manipulation of one or more number keys. A processor associated with the TV correlates the signal to a character string that typically includes one or more letters of an alphabet. The processor causes the TV to tune to a channel number understood by the processor to be the channel number of the desired station based on metadata contained in television programming.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a non-limiting block diagram of a system in accordance with present principles;

FIG. 2 is a plan view of a non-limiting remote control that can be used in accordance with present principles; and

FIG. 3 is a flow chart of logic that may be employed by the system of FIG. 1.

### DETAILED DESCRIPTION OF THE PREFERRED EMBODIMENT

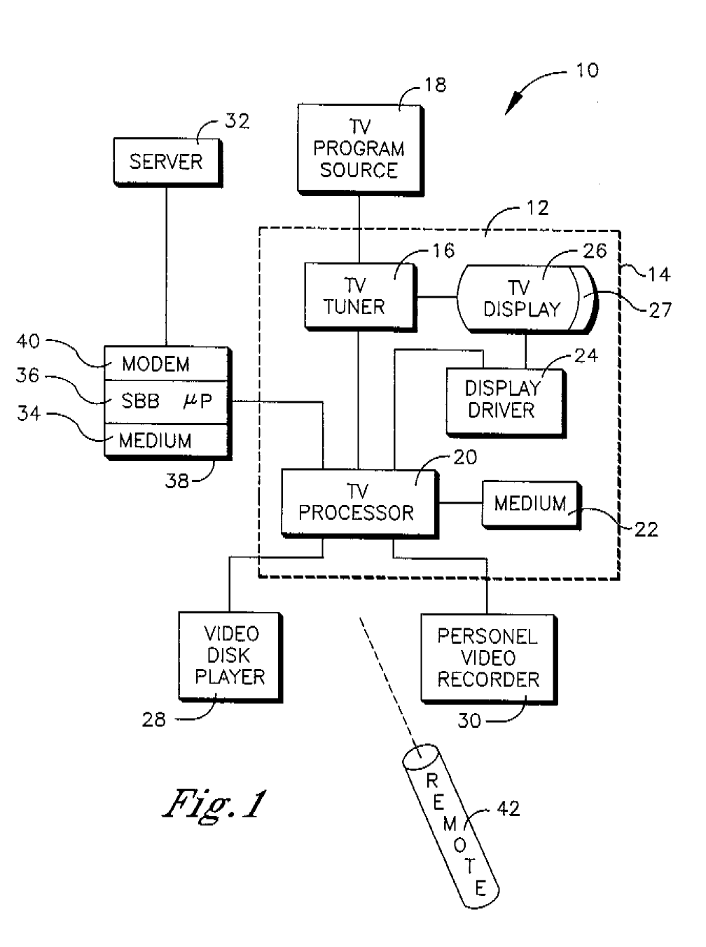

Referring initially to FIG. 1, a system is shown, generally designated 10, which includes a television 12 defining a TV chassis 14 and receiving, through a TV tuner 16 from a cable or satellite or other source or sources 18 audio video TV programming. The tuner 16 may be contained in the set box described below.

The TV 12 typically includes a TV processor 20 accessing a tangible computer readable medium 22. The tangible computer readable medium 22 may be established by, without limitation, solid state storage, optical or hard disk storage, etc. The medium 22 may store software executable by the TV processor 20 to, e.g., control a display driver 24 that drives a TV visual display 26 in accordance with one or more settings such as brightness, contrast, and the like that may be stored in, e.g., the medium 22. The display 26 may be a flat panel matrix display, cathode ray tube, or other appropriate video display, and typically is associated with one or more audio speakers 27. The medium 22 may also contain additional code including backend software executable by the TV processor 20 for various non-limiting tasks. One or more of the processors described herein may execute the logic below, which may be stored as computer code on one or more the computer readable media described herein.

In the non-limiting embodiment shown in FIG. 1 the TV 12 may receive programming from external components such as but not limited to a video disk player 28 such as a Blu-Ray or DVD player and a personal video recorder (PVR) 30 that can contain audio-video streams on a hard disk drive.

Additionally, the TV 12 can communicate via a network such as the Internet with a server 32. To this end, the TV 12 preferably is Internet-enabled, although it is to be understood that the server 32 may be combined with the TV program source 18 when the source 18 is a remote entity accessible over a wide area network, in which case no modem need be provided, with the TV sending signals through a reverse link to the source 18/server 32.

In the non-limiting embodiment shown, the server 32 is separate from the source 18 and the TV 12 communicates with the server 32 through a set-back box (SBB) 34. In some implementations a set-top box (STB) may be used, and the SBB/STB may itself include the tuner 16 or otherwise communicate with the source 18.

In any case, the SBB 34 shown in FIG. 1 may include a SBB processor 36 and SBB computer readable medium 38, The SBB 34 may also include a network interface such as but not limited to a modem 40 to communicate with the server 32 over the Internet. In other implementations the modem 40 may be incorporated into the TV chassis 14.

A wireless remote control 42 can be provided to input commands such as the below-described station commands into the system 10. The remote control 42 can be a conventional remote control or other portable hand-held device such as a wireless telephone upgraded with an IR transmitter for TVs to permit a viewer to tune to a TV channel in accordance with principles below.

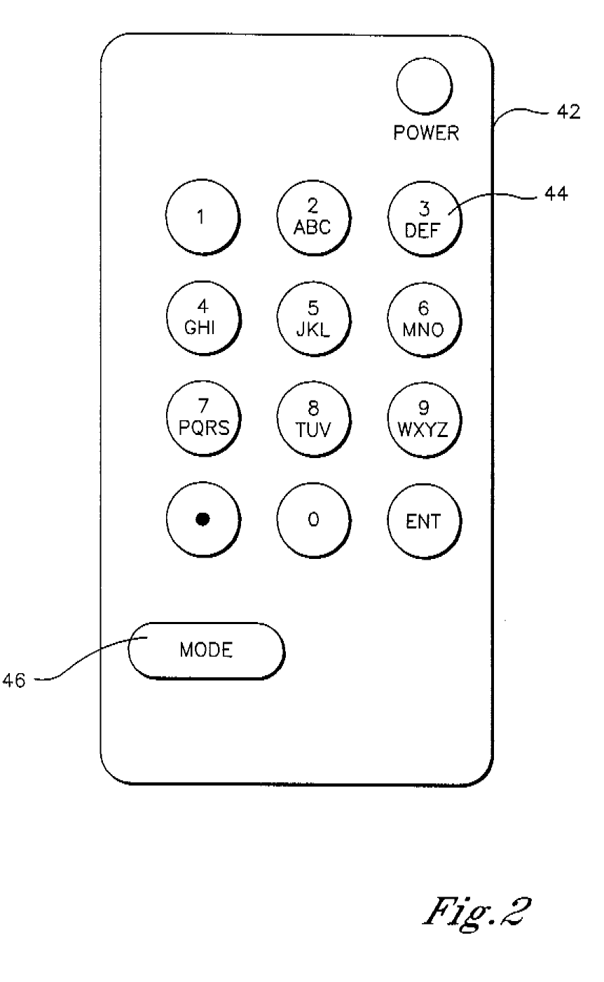

FIG. 2 shows an example remote control that includes ten number keys 44 with each number key being associated with respective alphabetic letters. In the embodiment shown, the number keys 44 are associated with the same letters typically associated with the number keys of a telephone. Accordingly, it will readily be appreciated that pressing the number “3”, for instance, can represent the numeral “3” and can also represent any one of the letters “d”, “e”, “f”. Less preferably, the remote control 42 may bear keys dedicated exclusively to letters.

For the embodiment shown, a “Mode” key 46 is also presented on the remote control 42. A viewer manipulates the mode key 46 to generate a signal indicating that the viewer is using the remote in a letter input mode, so that signals from the number keys 44 are interpreted by the TV to represent letters. The mode key 46 may be a special purpose key or it may be an existing key not normally used for TV input, e.g., a star key on a wireless telephone.

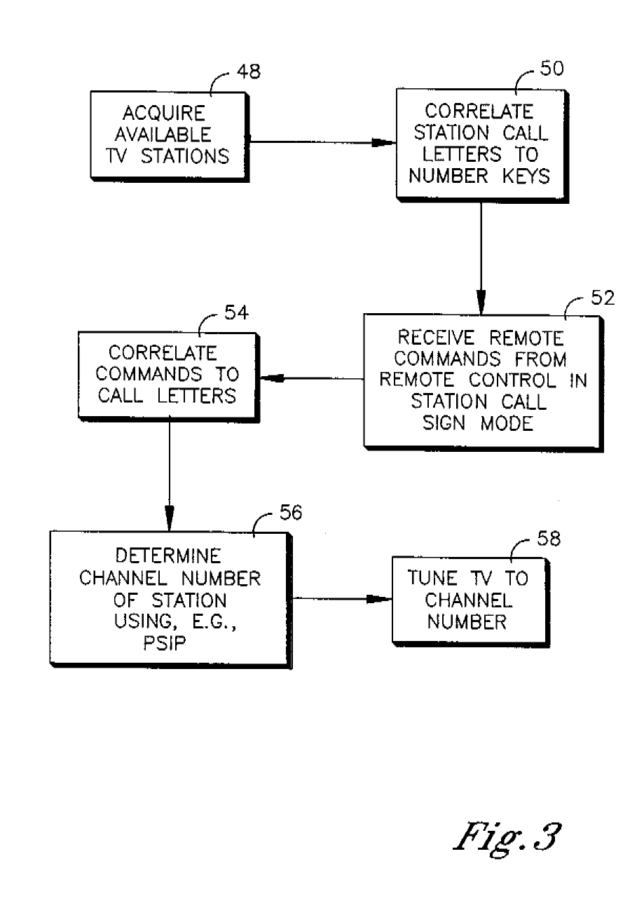

With this understanding in mind, attention is now drawn to FIG. 3, showing logic that may be employed by one or more of the processors described above to obviate the need for a viewer to remember which channel number a desired station is on. At block 48 the TV acquires available TV stations using, e.g., a Gemstar guide or through program and system information protocol (PSIP) data provided by the broadcaster. Proceeding to block 50, the call letters (which may also include symbols such as exclamation marks, which may be correlated to the numeral “1” on the keypad of the remote control) are correlated to sequences of number keys when a remote control such as the one shown in FIG. 2 is to be used that has only number keys. Thus, for instance, when a ten numeral keypad remote control 42 is to be used, “ABC” would be correlated to a number sequence “1”, “1”, “1”. Similarly, “ESPN”, assuming the remote control 42 shown in FIG. 2 is to be used, would be correlated to “3”, 7, “7”, “6”. If an available local station is determined to be an affiliate of a national network, the call sign of the local station may be correlated to both the number string representing the call sign and to the number string representing the call sign of the national network.

As understood herein, a viewer preferably has the option to input the channel number of a desired station directly or to input the call sign of a desired station, and to this end if the viewer wishes to alert the TV that the command is for the latter, the viewer first manipulates the “mode” key 46 shown in FIG. 2. The “mode” key 46 may act as a toggle. When it is toggled to “call sign” input, as opposed to “channel number” input, a user interface can be displayed on the TV so indicating. For example, an icon in the channel display banner can be presented indicating “call sign input mode”.

Assuming the viewer has entered the call sign entry mode, at block 52 remote commands are received from the remote control 42. The received string of commands from the number keys 44 are correlated at block 54 to the associated call sign letters. The channel number associated with the call sign letters is then determined at block 56 and the TV tuned to the channel at block 58. As numbers are entered, a user interface is displayed to list a choice of matching channels in alphabetical order. The user at this point can select one of the choices using the cursor keys or continue entering additional numbers to narrow down the list until only one entry exists at which point the TV can automatically tune to that entry. If no channel numbers are correlated to the call sign, the viewer is so informed by, e.g., an error message or audio cue, and the TV remains tuned to the current channel.

In one implementation, a lookup table derived from, e.g., an electronic program guide (EPG) that associates station call signs with channel numbers can be accessed to undertake the function of block 56, but more preferably the association is undertaken dynamically after receiving the command representing the call sign input mode or even after receiving the desired station call sign. In one implementation metadata in the received televised stream is used to determine which station call sign is associated with which local channel number. For example, in digital TV signals, program and system information protocol (PSIP) data can be accessed, which indicates, for the stream on a given channel number, the call sign of the associated station.

While the particular CHANNEL SELECTION BY NAME is herein shown and described in detail, it is to be understood that the subject matter which is encompassed by the present invention is limited only by the claims.

1. A method comprising:
receiving, at a TV, a signal from a wireless commander;
determining an alphabetic station identification from the signal;
accessing metadata in incoming TV signals to determine a channel number associated with the station identification; and
tuning the TV to the channel number, wherein if an available local station is determined to be an affiliate of a national network, the alphabetic station identification is correlated to both the channel number and to a number string representing the call sign of the national network.

2. The method of claim 1, wherein the metadata is accessed dynamically after receipt of the signal from the wireless commander.

3. The method of claim 1, wherein the wireless commander is a wireless telephone.

4. The method of claim 1, wherein the wireless commander is a TV remote control.

5. The method of claim 1, wherein the station identification is alphanumeric in that it includes at least one letter.

6. The method of claim 1, wherein the metadata is program and system information protocol (PSIP) data.

7. A system, comprising:
a TV display;
a processor associated with the TV display; and
a tuner controllable by the processor to cause programming from a tuned-to channel number to be presented on the display;
the processor receiving user-generated signals and correlating the signals to a station call sign, the processor correlating the call sign to a channel number using information received in TV programming, wherein as user-generated signals are received, a user interface is presented on the TV display listing channels matching call signs represented by the signals in alphabetical order, a user being given the option between selecting one of the channels or continuing entering additional numbers to narrow down the list until only one entry exists at which point the TV automatically tunes to the one entry.

8. The system of claim 7, wherein the information is metadata in at least one program stream.

9. The system of claim 8, wherein the metadata is associated with a digital TV signal.

10. The system of claim 9, wherein the metadata is program and system information protocol (PSIP) data.

11. The system of claim 7, wherein the user-generated signals include a station call sign select mode signal.

12. The system of claim 7, wherein the metadata is accessed dynamically by the processor after receipt of the user-generated signals.

13. The system of claim 7, wherein the user-generated signals are from a wireless telephone.

14. The system of claim 7, wherein the user-generated signals are from a TV remote control.

15. The system of claim 7, wherein the station call sign includes at least one letter.

16. Apparatus for obviating the need for a viewer to remember a channel number of a desired station having an alphabetic identification, comprising:
a TV receiving a signal from a viewer-operated input device, the signal being input by manipulation of one or more number keys; and
a processor associated with the TV correlating the signal to a character string including at least one letter of an alphabet, a correlation of the character string to a channel number being undertaken dynamically after receiving a user-generated signal by accessing metadata within a received televised stream to determine subsequent to receipt of the user-generated signal which station call sign is associated with which local channel number;
the processor causing the TV to tune to a channel number understood by the processor to be the channel number of a desired station associated with the character string based on metadata contained in television programming, wherein the metadata that is accessed to correlate the station identification to a channel number is real time program and system information protocol (PSIP) data.

17. The apparatus of claim 16, wherein the input device is a TV remote control.

18. The apparatus of claim 16, wherein the input device is a wireless telephone.

19. The apparatus of claim 16, wherein the processor correlates the signal from the input device to the character string only if a mode signal is first received indicating station name input mode.

20. The apparatus of claim 16, wherein the metadata is contained in a digital TV signal.
